(19) United States
(12) Patent Application Publication
(10) Pub. No.: US 2007/0122678 A1
(43) Pub. Date: May 31, 2007

(54) Liquid supply joint device and fuel cell system using the same

(76) Inventors: Toru Takahashi, Sagamihara-shi (JP); Nobuo Katsuura, Yokohama-shi (JP)

Correspondence Address: NIXON PEABODY, LLP, 401 9TH STREET, NW, SUITE 900, WASHINGTON, DC, 20004-2128, US

(21) Appl. No.: 11/603,232

(22) Filed: Nov. 22, 2006

(30) Foreign Application Priority Data
Nov. 25, 2005 (JP) 2005-340562

(51) Int. Cl. H01M 8/04; E03B 11/00

(52) U.S. Cl. 429/34; 137/572

(57) ABSTRACT

A liquid supply joint device whose structure is simplified and that is accordingly composed of a small number of components, is small in size, can be manufactured at low cost, and can prevent liquid leakage under a wide range of conditions without being affected by internal pressure, whether high or low, is provided. The liquid supply joint device includes: a housing 10 that can be placed at at least one of the liquid reservoir and the liquid accepter and has a liquid supply port 11 and a discharge port 12; and a valve body 50 that is placed and movable in the housing 10 and opens or closes the supply port 11 or the discharge port 12 in accordance with movement of the valve body 50. Either the housing 10 or the valve body 50 is composed of an elastic member. The valve body 50 has a sealing face 53 that is generally parallel to the direction of its movements, and the valve body 50 is closed when the sealing face 53 is made to come into contact with the inside wall of the housing 10.

### CROSS-REFERENCES TO RELATED APPLICATIONS

This application relates to and claims priority from Japanese Patent Application No. 2005-340562, filed on Nov. 25, 2005, the entire disclosure of which is incorporated herein by reference.

### BACKGROUND

1. Technical Field

The present invention relates to a liquid supply joint device for guiding a liquid from a liquid reservoir to a liquid accepter in a liquid supply means for, for example, a fuel cell or an ink-jet printer. This invention also relates to a fuel cell system equipped with such a liquid supply joint device.

2. Related Art

A liquid supply means to which a liquid reservoir containing and discharging a liquid, and a liquid accepter for receiving the liquid from the liquid reservoir, can be attached is now widely used for, for example, ink-jet printers, lighters using liquid fuel, and chemical liquid administration for medical treatment. In the liquid supply means, the liquid reservoir itself can be directly replaced when it runs short of the liquid to be supplied. Accordingly, compared to the case where the liquid is supplied directly to, for example, a reserve tank mounted on a main body of the liquid supply means, users can supply the liquid to the liquid reservoir more easily and safely without dirtying their hands so much with the liquid. In particular, this liquid supply means is very effective in the case where the liquid to be supplied has an affect on the human body or may severely deteriorate if exposed to the outside air.

Also, the development of fuel cells that generate electric power by using a liquid as fuel is being promoted these days. In particular, many electric-appliance makers are actively promoting the development of direct methanol fuel cells (DMFC) that use methanol as fuel. The DMFCs are expected to be new batteries for the next generation that can be used for, for example, notebook personal computers, various portable electronics, and cell phones. However, in general, methanol has a considerable affect on the human body. If man inhales methanol, it may damage the central nervous system and cause dizziness and diarrhea. If man inhales a large amount of methanol or methanol enters his eyes, methanol may cause optic nerve disorder and there is a high possibility of loss of sight. Accordingly, methanol is a highly dangerous toxic liquid. Therefore, in order to safely and easily supply fuel to general consumers of DMFCs, a means of supplying methanol to a liquid reservoir as a cartridge without directly touching methanol is considered to be the optimum means, and the development of such means is being widely promoted. (See, for example, JP2003-308871 A, JP8-12301 A, and JP2003-317756 A).

The above-described liquid supply means needs to have a liquid supply joint device that guides the liquid from a liquid reservoir to a liquid accepter and can be attached to the liquid reservoir and/or the liquid accepter. Various types of conventional joint devices have been introduced. (See, for example, JP10-789 A, JP8-50042 A, JP 2003-528699 T, JP2003-266739 A, JP2001-524896 T, JP2000-289225 A, JP7-68780 A, JP5-254138 A, and JP2003-331879 A).

However, since all of these joint devices have many components and complicated structures, there are size and cost reduction limitations. Moreover, since the joint device is structured so that a valve or similar opens when supplying a liquid, liquid leakage may easily occur if the internal pressure of the liquid reservoir and the accepter increases. Accordingly, there is a strong need for a joint device whose joint structure is simplified, that does not cause liquid leakage under high internal pressure, and that can be smoothly attached to the liquid reservoir and/or liquid accepter.

In the case of a joint device that is structured to close its valve to stop the liquid supply, and of the type that is sealed by causing a surface of the valve generally perpendicular to the valve movement direction (“generally parallel surface”) to come into contact with the inside wall of the housing in which the valve is placed, it is necessary to secure a certain amount of area of the generally parallel surface in order to seal the valve with certainty. As a result, a large area of the valve is exposed from the liquid reservoir cartridge. This is one of factors that make it difficult to reduce the size of the joint device and therefore the size of the liquid reservoir.

### SUMMARY

The present invention was devised in light of the circumstances described above. It is an object of the invention to provide: a liquid supply joint device whose structure is simplified and that is composed of a small number of components, is small in size, can be manufactured at low cost, and can prevent liquid leakage under a wide range of conditions without being affected by internal pressure, whether high or low; and a fuel cell system equipped with such a liquid supply joint device.

In order to achieve the above-described object, according to an aspect of the invention, a liquid supply joint device for connecting a liquid reservoir containing a liquid to a liquid accepter for receiving the liquid from the liquid reservoir is provided. This liquid supply joint device includes: a housing that can be placed at at least one of the liquid reservoir and the liquid accepter and has a liquid supply port and a discharge port; and a valve body that is placed and movable in the housing and opens or closes the supply port or the discharge port in accordance with movements of the valve body, wherein either the housing or the valve body is composed of an elastic member, and wherein the valve body has a sealing face that is generally parallel to the direction of its movement, and the valve body is closed when the sealing face is made to come into contact with the inside wall of the housing.

The liquid supply joint device having the above-described structure is configured so that the valve is closed by positioning the sealing face of the valve body generally parallel to the movement direction of the valve body and making the sealing face come into contact with the inside wall of the housing. Accordingly, it is possible to simplify the structure, reduce the number of components, realize a size reduction, manufacture the liquid supply joint device at low cost, and prevent liquid leakage under a wide range of conditions without being affected by internal pressure, whether high or low.

In the liquid supply joint device according to the invention, the housing can be composed of an elastic member. Accordingly, in addition to the advantageous effects described above, the sealing face of the valve body can be made to come into contact with the inside wall of the housing with more certainty.

The liquid supply joint device according to the invention may also be configured so that a force-applying member for applying force to the valve body to make it move is provided in the housing.

Moreover, the liquid supply joint device according to the invention may be configured so that a force-applying member for applying force to the valve body to make it move is formed integrally with the inside wall of the housing.

Furthermore, the valve body may be configured so that channels for allowing the liquid to flow through are formed at an end portion of the valve body on the side to be closed; and when the valve body is opened, the liquid is made to flow through the channels.

The valve body can be configured so that when the valve body moves, the sealing face slides along the inside wall of the housing.

Furthermore, the liquid supply joint device according to the invention may be configured so that either at least the sealing face of the valve body or at least a sliding face of the housing along which the sealing face slides, or both are made of a sliding material. Accordingly, in addition to the advantageous effects described above, the valve body can be moved more smoothly.

Also, according to an aspect of the invention, a fuel cell system including: a fuel cell; a liquid reservoir containing liquid fuel; a liquid accepter for receiving the liquid fuel from the liquid reservoir and supplying it to the fuel cell; and the aforementioned liquid supply joint device is provided.

Since the fuel cell system having the above-described structure is equipped with the liquid supply joint device having the advantageous effects described above, it is possible to simplify its structure, reduce the number of components, realize the size reduction, and manufacture the fuel cell system at low cost.

Also, the liquid fuel for the fuel cell system according to the invention can contain methanol.

As described above, the liquid supply joint device according to the invention is configured so that the valve body is closed by making the sealing face, which is generally parallel to the movement direction of the valve body, come into contact with the inside wall of the housing. Accordingly, it is possible to simplify its structure, reduce the number of components, realize a size reduction, and manufacture the liquid supply joint device at low cost. Also, the liquid supply joint device has the effect of preventing liquid leakage under a wide range of conditions without being affected by internal pressure, whether high or low.

Furthermore, since the fuel cell system according to the invention is equipped with the liquid supply joint device according to the invention, it has the effect of simplifying its structure, reducing the number of components, realizing a size reduction, and manufacturing the fuel cell system at low cost.

### BRIEF DESCRIPTION OF THE DRAWINGS

FIG. 1 is a cross-sectional view of a liquid supply joint device according to the first embodiment of the invention where its valve body is in the closed position.

FIG. 2 is a cross-sectional view of the liquid supply joint device according to the first embodiment where its valve body is in the open position.

FIG. 3 is a plan view of the valve body for the liquid supply joint device in FIGS. 1 and 2, as seen from the left side of FIG. 1.

FIG. 4 is a side view of the valve body for the liquid supply joint device in FIGS. 1 and 2.

FIG. 5 is a cross-sectional view of a liquid reservoir housing to which the liquid supply joint device shown in FIGS. 1 and 2 is attached, and a liquid accepter housing to be connected to the liquid reservoir housing before they are connected to each other.

FIG. 6 is a cross-sectional view of the housings in FIG. 5 when they are connected to each other via the liquid supply joint device in FIGS. 1 and 2.

FIG. 7 is a cross-sectional view of a liquid supply joint device according to the second embodiment of the invention when it is attached to a housing and its valve body is in the closed position.

FIG. 8 is a cross-sectional view of a liquid reservoir housing to which the liquid supply joint device shown in FIG. 7 is attached, and a liquid accepter housing to be connected to the liquid reservoir housing before they are connected to each other.

FIG. 9 is a cross-sectional view of the housings shown in FIG. 8 when they are connected to each other via the liquid supply joint device.

FIG. 10 is a cross-sectional view of a housing to which a liquid supply joint device according to another embodiment of the invention is attached, and a liquid accepter housing to be connected to the liquid reservoir housing before they are connected to each other.

FIG. 11 is a cross-sectional view of the housings shown in FIG. 10 when they are connected to each other via the liquid supply joint device.

FIG. 12 is a cross-sectional view of a housing to which a liquid supply joint device according to another embodiment of the invention is attached, and a liquid accepter housing to be connected to the liquid reservoir housing before they are connected to each other.

FIG. 13 is a cross-sectional view of the housings shown in FIG. 12 in when they are connected to each other via the liquid supply joint device.

FIG. 14 is a cross-sectional view of a housing to which a liquid supply joint device according to another embodiment of the invention is attached, and a liquid accepter housing to be connected to the liquid reservoir housing before they are connected to each other.

FIG. 15 is a cross-sectional view of the housings shown in FIG. 14 when they are connected to each other via the liquid supply joint device.

FIG. 16 is a schematic diagram of a fuel cell system according to the first embodiment of the invention.

### DETAILED DESCRIPTION OF PREFERRED EMBODIMENTS

A liquid supply joint device according to preferred embodiments of the invention will be described below with reference to the attached drawings. The embodiments described below are for the purpose of describing this invention, but the invention is not limited only to those embodiments. Accordingly, this invention can be utilized in various ways unless those utilizations depart from the gist of the invention.

### First Embodiment

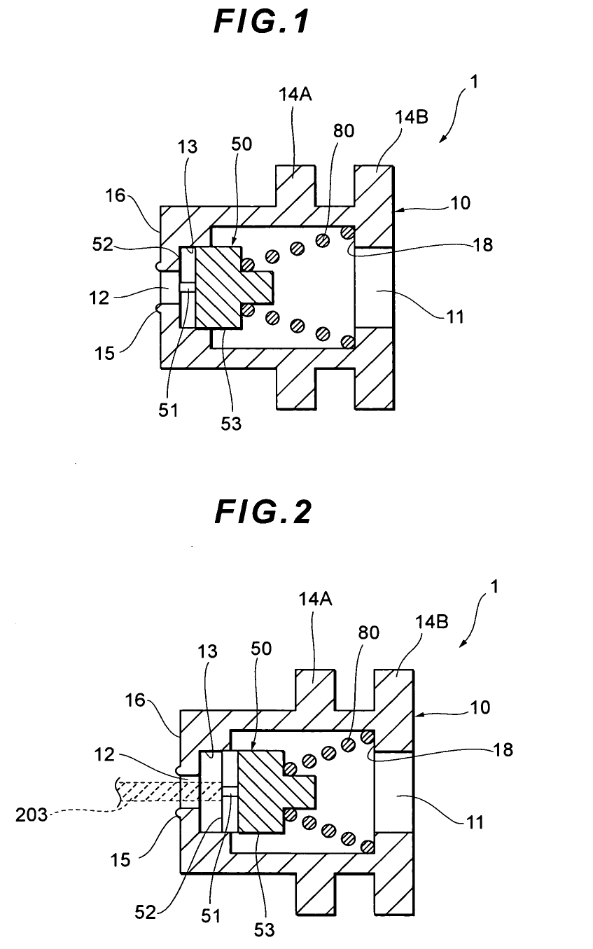

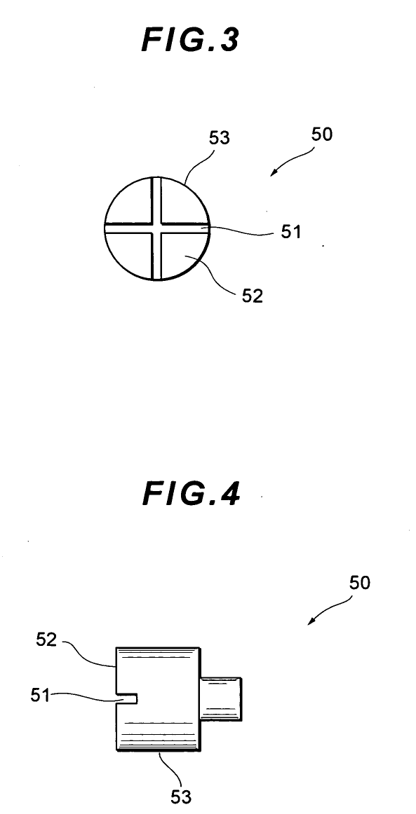

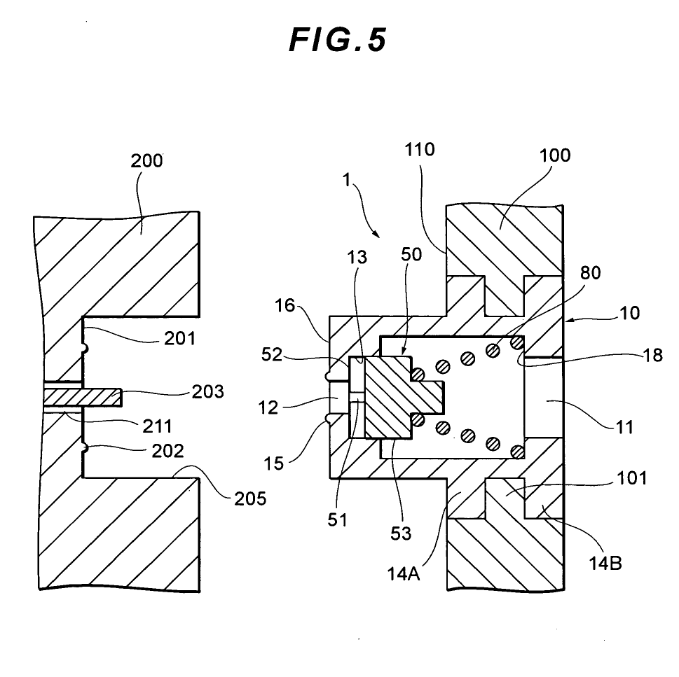

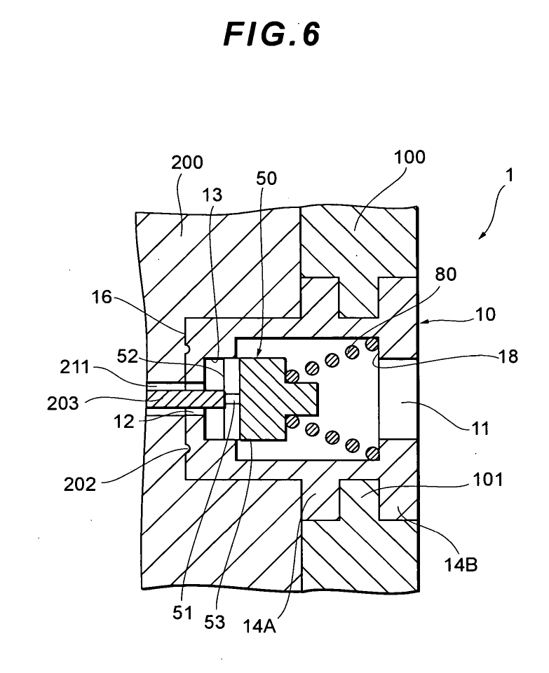

FIG. 1 is a cross-sectional view of a liquid supply joint device according to the first embodiment of the invention where its valve body is in the closed position. FIG. 2 is a cross-sectional view of the liquid supply joint device according to the first embodiment where its valve body is in the open position. FIG. 3 is a plan view of the valve body for the liquid supply joint device in FIGS. 1 and 2, as seen from the left side of FIG. 1. FIG. 4 is a side view of the valve body for the liquid supply joint device in FIGS. 1 and 2. FIG. 5 is a cross-sectional view of a liquid reservoir housing to which the liquid supply joint device shown in FIGS. 1 and 2 is attached, and a liquid accepter housing to be connected to the liquid reservoir housing. FIG. 6 is a cross-sectional view of the housings in FIG. 5 when they are connected to each other via the liquid supply joint device in FIGS. 1 and 2.

As shown in FIGS. 1 to 6, a liquid supply joint device 1 according to the first embodiment is a device for connecting a liquid reservoir containing a liquid to a liquid accepter for receiving the liquid from the liquid reservoir. The liquid supply joint device 1 includes: a housing 10; a valve body 50 placed in the housing 10 in such a way that the valve body 50 can move in the housing 10; and a spring 80 for applying force to the valve body 50.

The housing 10 is made of an elastic member (a material that can elastically change its shape), and can contain a liquid. This housing 10 has: a supply port 11 for supplying the liquid from a liquid reservoir (not shown in the drawing) into the housing 10; and a discharge port 12 for discharging the liquid contained in the housing 10 to a liquid accepter (not shown in the drawing). Also, a valve-body-press-in part 13 of a generally cylindrical shape that is complementary to the shape of the valve body 50, and into which the valve body 50 can be pressed, and along which the pressed-in valve body 50 can slide, is formed inside the housing 10 on the discharge port 12 side. Furthermore, a valve seat 18 for fastening one end of a spring 80 described later in detail is formed inside the housing 10 on the supply port 11 side.

Various known elastic materials such as various types of rubbers and elastomers can be used as materials for the housing 10. Specific examples of the elastic materials include: styrene butadiene rubber, butadiene rubber, syndiotactic 1,2-polybutadiene, isoprene rubber, acrylonitrile-butadiene rubber, chloroprene rubber, ethylene-propylene rubber, ethylene-propylene terpolymer, butyl rubber, acrylic rubber, chlorosulfonated polyethylene, silicon rubber, vinylidene fluoride-hexafluoropropylene rubber, tetrafluoroethylene-propylene rubber, tetrafluoroethylene perfluoromethyl vinyl ether rubber, fluorosilicon rubber, epichlorohydrin rubber, polysulfide rubber, urethane rubber, and natural rubber. One of these rubber types or a combination of two or more types can be used. It is desirable to select the material of the housing 10 according to the properties of the liquid to be sent or received, and according to the properties of the elastic member such as slide, permanent compressive strain, rebound resilience, and elution resistance. If the liquid reservoir is a methanol fuel cartridge used in a DMFC and a 3 wt % methanol solution is to be sealed in the liquid reservoir, ethylene-propylene rubber, which has excellent methanol resistance and permanent compressive strain, can be used. In this case, the liquid accepter can contain a DMFC main body (product number 6061; manufactured by Eifrig Inc.).

Ribs 14A and 14B for attaching the housing 10 to a liquid reservoir housing 100 (see FIGS. 5 and 6) are formed on the outside surface of the housing 10 on the supply port 11 side. The ribs 14A and 14B may be attached to the housing 100 in such a way that liquid leakage will not be caused from the part attached to the housing 100. In order to prevent leakage from the part attached to the housing 100, the housing 10 and the housing 100 may be integrally molded by means of, for example, insert molding or two-color molding.

A labyrinth seal 15 of a protruding shape is formed on the outside end face 16 of the housing 10 on the discharge port 12 side. This labyrinth seal 15 may be formed so that it protrudes from the outside end face 16 around the discharge port 12. Incidentally, the cross-section of the protruding part of the labyrinth seal 15 in the first embodiment has a semicircle shape. However, the cross-sectional shape of the protruding part of the labyrinth seal 15 is not particularly limited and may be a reversed V shape or a quadrangle. Also, the outside end face 16 constitutes a joint face to be connected to a liquid accepter housing 200 (see FIGS. 5 and 6).

A labyrinth seal 202 of a protruding shape, which will be described later in detail, is formed on a joint face 201 of the housing 200 (see FIGS. 5 and 6) to come into contact with the outside end face 16 of the housing 10. This labyrinth seal 202 is formed so that it will be located at a position offset from the labyrinth seal 15 when the outside end face 16 (the joint face ) of the housing 10 touches the joint face 201 of the housing 200. Accordingly, when the outside end face 16 of the housing 10 is connected to the joint face 201 of the housing 200, dual labyrinth seal effects can be obtained. As a result, it is possible to prevent liquid leakage with certainty and ensure high reliability.

In some cases, the labyrinth seals 15 and 202 may not necessarily be formed because a contact pressure between the outside end face 16 and the joint face 201 is high or the outside end face 16 and the joint face 201 have high adhesiveness to each other when the liquid reservoir housing 100 is connected to the liquid accepter housing 200 via the liquid supply joint device 1. Also, either of the labyrinth seals 15 and 202 may be provided. Furthermore, the labyrinth seals 15 and 202 can be designed in consideration of, for example, connection conditions and the materials for the housing 10 in order to prevent liquid leakage.

The valve body 50 has a generally cylindrical shape so that it can be pressed into the valve-body-press-in part 13, which is generally cylindrical and is formed inside the housing 10, and can slide along the valve-body-press-in part 13. This valve body 50 has channels 51 formed therein on its one end portion closer to the discharge port 12 side of the housing 10. As shown in FIG. 3, these channels 51 are composed of generally-cross-shaped grooves on the end face 52 of the valve body 50 opposite the discharge port 12. The valve body 50 can move in the valve-body-press-in part 13 in back-and-forth movement directions relative to the discharge port 12 (from side to side as shown in FIGS. 1 and 2). The outside side surface of the valve body 50 (i.e., the surface generally parallel to the movement directions of the valve body 50) constitutes a sealing face 53 that can seal a space between the valve body 50 and the inside wall of the valve-body-press-in part 13.

When a force applied by the spring 80, whose one end is fastened to the valve seat 18 formed inside the housing 10 and other end is fastened to one end portion of the valve body 50, causes a portion of the valve body 50, including the area where the sealing face 53 is formed, to be inserted into the valve-body-press-in part 13 (see FIG. 1), the valve 50 is closed and liquid discharge to the liquid accepter is stopped. On the other hand, when a valve-body-pressing pin 203 (see FIGS. 5 and 6) attached to the liquid accepter housing 200 presses the valve body 50 toward the supply port 11 and causes a portion of the valve body 50, i.e., part of the area where the channels 51 are formed, to be inserted into the valve-body-press-in part 13, the channels 51 are partly exposed from the valve-body-press-in part 13 (see FIG. 2), thereby opening the valve body 50 and discharging the liquid through the channels 51 to the liquid accepter. Incidentally, the valve body 50 is normally open because of the force applied by the spring 80.

There is no particular limitation on types of materials to be used to form the valve body 50 as long as the valve body 50 can be pressed into and slide along the valve-body-press-in part 13 and can seal the space between the valve body 50 and the inside wall of the valve-body-press-in part 13. However, examples of the material of the valve body 50 can include metals, plastics, woods, and ceramics. Of those, metals and plastics are more preferable. Specific examples of the metals include: stainless steel, aluminum, iron, copper, silver, platinum, and gold. Specific examples of the plastics include: polyethylene, polypropylene, polyvinyl chloride resin, polystyrene, ABS resin, methacrylic resin, polyethyleneterephthalate, polyamide, polycarbonate, polyacetal, polybutylene terephthalate, modified polyphenylene ether, polyphenylene sulfide, liquid crystal polymer, polysulfone, polyether sulfone, polyallylate, polyether ether ketone, polyphthal amide, polyimide, polyether-imide, polyamide-imide, polymethyl pentene, fluororesin, polyvinylidene fluoride, TEFE, PFA, phenolic resin, urea resin, melamine resin, unsaturated polyester, diallyl phthalate, epoxy resin, polyurethane resin, and silicon resin. Regarding the first embodiment, polypropylene, which is highly resistant to methanol, is used in consideration of the fact that it is used in a DMFC.

As shown in FIGS. 5 and 6, the liquid reservoir housing 100 has a protruding part 101 that engages with a recess defined by the ribs 14A and 14B formed on the housing 10 of the liquid supply joint device 1. The liquid supply joint device 1 is attached to the liquid reservoir by having the protruding part 101 engage with the recess between the rib 14A and the rib 14B. This housing 100 is structured so that its end face 110 to be connected to the housing 200 becomes flush with the end face closer to the discharge port 12, of the rib 14A of the housing 10. Because of this structure, the liquid supply joint device 1 is attached to the housing 100 in such a way that the portion of the liquid supply joint device 1 extending from the rib 14A toward the discharge port 12 protrudes from the end face 110 of the housing 100.

As shown in FIGS. 5 and 6, the liquid accepter housing 200 has a connection recess 210 for engaging with the protruding portion of the liquid supply joint device 1 that protrudes from the rib 14A toward the discharge port 12 and also from the housing 100, thereby connecting the liquid supply joint device 1 to the liquid accepter housing 200. The aforementioned labyrinth seal 202 is formed on a joint face 201 of the connection recess 210. Also, a valve-body-pressing pin 203 is formed on and protrudes from the substantially central part of the joint face 201 in such a way that the valve-body-pressing pin 203 can move back and forth.

When the housing 100 is connected to the housing 200 and the liquid is allowed to flow from the liquid reservoir through the liquid supply joint device 1 to the liquid accepter, the valve-body-pressing pin 203 presses the valve body 50 toward the housing 100 against the force applied by the spring 80 and moves the valve body 50 to the open position, thereby opening the valve body 50. The liquid supplied by the above-described action from the liquid reservoir into the housing 10 flows through the channels 51 formed in the valve body 50 and then a liquid supply passage 211 formed around the valve-body-pressing pin 203, and finally reaches the liquid accepter.

On the other hand, in order to stop the liquid flow into the liquid accepter, the valve-body-pressing pin 203 is moved backward to separate it from the valve body 50, and the force applied by the spring 80 then moves the valve body 50 to the closed position, thereby closing the valve body 50.

If the liquid reservoir housing 100 is connected to the liquid accepter housing 200 via the liquid supply joint device 1 as shown in FIG. 6, the labyrinth seal 15 formed on the housing 10 of the liquid supply joint device 1 elastically changes its shape and becomes almost squashed, thereby further enhancing sealability.

In a conventional liquid supply joint device (conventional product) that closes its valve by having a surface corresponding to the joint face 201 in the first embodiment come into contact with a surface corresponding to the outside end face 16, it is necessary to secure a certain amount of area of the surfaces to be sealed (the surface corresponding to the joint face 201 in the first embodiment and the surface corresponding to the outside end face 16) in order to close the valve body with certainty. Accordingly, it is necessary to increase the radial length of the liquid supply joint device to a certain extent. This has been one of the factors that hamper the size reduction.

On the other hand, in the case of the liquid supply joint device 1 according to the first embodiment, the valve body 50 is closed by sealing the space between the sealing face 53, which is generally parallel to the movement direction of the valve body 50, and the inside wall of the valve-body-press-in part 13. Accordingly, it is unnecessary to increase the radial length of the liquid supply joint device and a size reduction can be achieved.

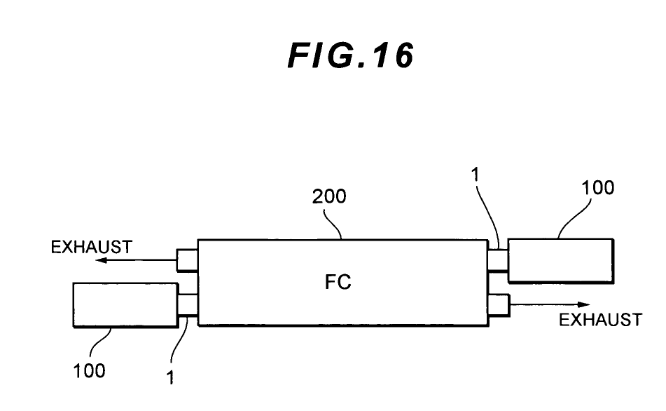

If a fuel cell is used as the liquid accepter, the housing 200, which is a fuel cell FC, may be connected via the liquid supply joint device 1 to the liquid accepter housing 100 containing liquid fuel as shown in FIG. 16. FIG. 16 is a schematic diagram of a fuel cell system according to the first embodiment of the invention.

The first embodiment described the case where the housing 10 is composed of an elastic member and the valve body 50 is composed of a material that cannot elastically change its shape so well compared to the housing 10. However, the materials for the housing 10 and the valve body 50 are not limited to the examples described above, and the valve body 50 may be composed of an elastic member and the housing 10 may be composed of a material that cannot elastically change its shape so well compared to the valve body 50. If the valve body 50 is composed of an elastic member, various known elastic materials such as various types of rubbers and elastomers can be used. Specific examples of the elastic materials include: styrene butadiene rubber, butadiene rubber, syndiotactic 1,2-polybutadiene, isoprene rubber, acrylonitrile-butadiene rubber, chloroprene rubber, ethylene-propylene rubber, ethylene-propylene terpolymer, butyl rubber, acrylic rubber, chlorosulfonated polyethylene, silicon rubber, vinylidene fluoride-hexafluoropropylene rubber, tetrafluoroethylene-propylene rubber, tetrafluoroethylene perfluoromethyl vinyl ether rubber, fluorosilicon rubber, epichlorohydrin rubber, polysulfide rubber, urethane rubber, and natural rubber. The rubber types can be used alone, or in combination.

If the housing 10 is composed of a material that cannot elastically change its shape so well compared to the valve body 50, materials such as metals, plastics, woods, and ceramics can be used. Of those, metals and plastics are more preferable. Specific examples of the metals include:

stainless steel, aluminum, iron, copper, silver, platinum, and gold. Specific examples of the plastics include: polyethylene, polypropylene, polyvinyl chloride resin, polystyrene, ABS resin, methacrylic resin, polyethyleneterephthalate, polyamide, polycarbonate, polyacetal, polybutylene terephthalate, modified polyphenylene ether, polyphenylene sulfide, liquid crystal polymer, polysulfone, polyether sulfone, polyallylate, polyether ether ketone, polyphthal amide, polyimide, polyether-imide, polyamide-imide, polymethyl pentene, fluororesin, polyvinylidene fluoride, TEFE, PFA, phenolic resin, urea resin, melamine resin, unsaturated polyester, diallyl phthalate resin, epoxy resin, polyurethane resin, and silicon resin.

In order to further improve the ability of the valve body 50 to slide along the valve-body-press-in part 13, at least the sealing face 53 of the valve body 50 or at least the sliding face of the housing 10 along which the sealing face 53 slides may be formed of or coated with a sliding material.

The first embodiment described the case where the liquid supply joint device 1 is placed in the liquid reservoir housing 100. However, the configuration of the liquid supply joint device 1 is not limited to the above-described example, and the liquid supply joint device 1 may be placed in the liquid accepter housing 200.

### Second Embodiment

Next, a liquid supply joint device according to the second embodiment of the invention will be described below with reference to the relevant drawings.

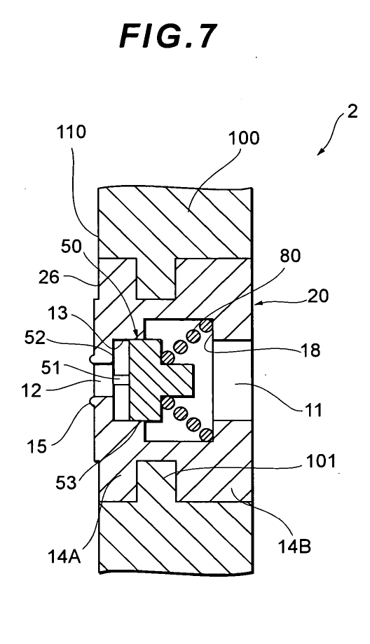

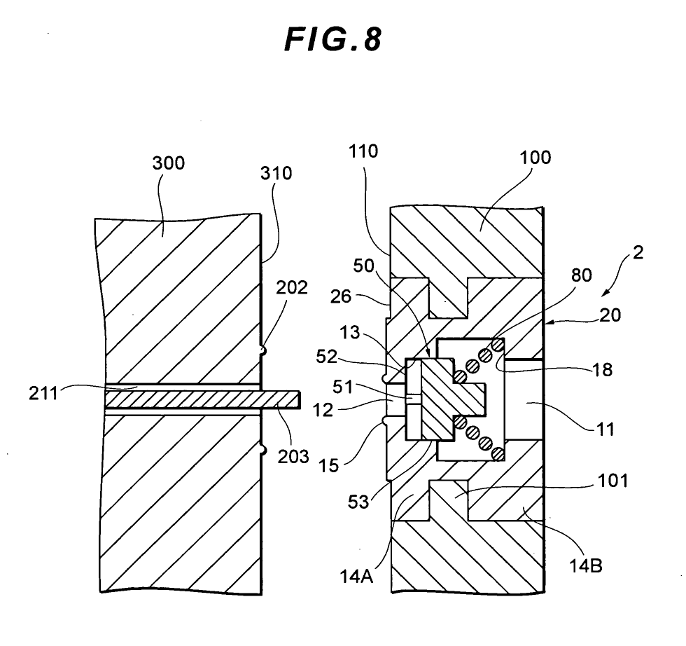

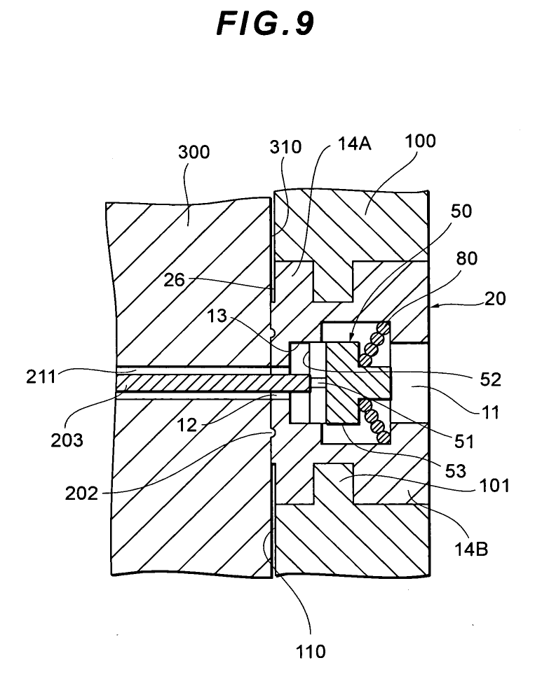

FIG. 7 is a cross-sectional view of a liquid supply joint device according to the second embodiment of the invention when it is attached to a housing and its valve body is in the closed position. FIG. 8 is a cross-sectional view of a liquid reservoir housing to which the liquid supply joint device shown in FIG. 7 is attached, and a liquid accepter housing to be connected to the liquid reservoir housing before they are connected to each other. FIG. 9 is a cross-sectional view of the housings shown in FIG. 8 when they are connected to each other via the liquid supply joint device.

Elements used in the second embodiment the same as those used in the first embodiment are given the same reference numerals as in the first embodiment, so their detailed description has been omitted.

As shown in FIGS. 7 to 9, the main difference between a liquid supply joint device 2 according to the second embodiment and the liquid supply joint device 1 according to the first embodiment is that the outside end face 26 of a housing 20 is generally flush with the end face 110 of the housing 100.

The housing 20 is formed so that the length of the housing 20 in the movement direction of the valve body 50 is shorter than that of the housing 10 in the liquid supply joint device 1 according to the first embodiment. A generally central part of the outside end face 26 is slightly raised compared to the outside area of that central part. However, the outside end face 26 as a whole is generally flush with the end face of the rib 14A.

In the case of this configuration, an end face 310 (joint face) of a liquid accepter housing 300 is generally flat as shown in FIG. 8. The liquid reservoir housing 100 is connected to the liquid accepter housing 300 via the liquid supply joint device 2 by having the outside end face 26 of the liquid supply joint device 2 come into contact with the end face 310 as shown in FIG. 9. Incidentally, in the second embodiment, the housing 100 and the housing 300 are fastened tightly by fastening means such as fittings, bolts, and screws not shown in the drawings.

The action of the liquid flowing from the liquid reservoir to the liquid accepter via the liquid supply joint device 2 and the action to stop the liquid flow are similar to those of the liquid supply joint device 1 according to the first embodiment.

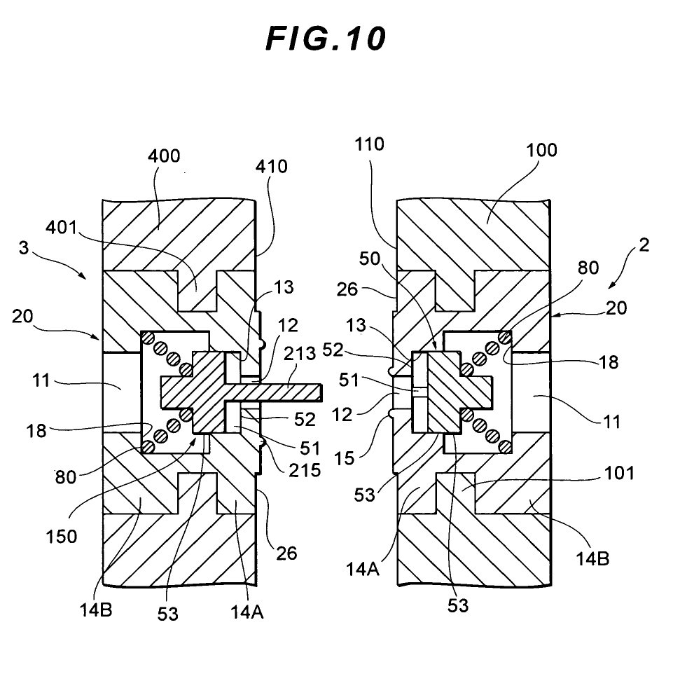

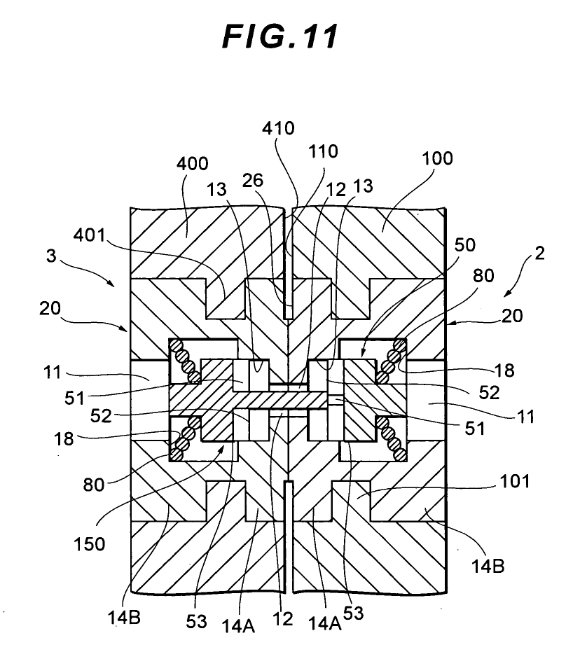

If the liquid supply joint device 2 according to the second embodiment is applied, a liquid supply joint device 3 may be placed in a liquid accepter housing 400 as shown in FIGS. 10 and 11. The main difference between the liquid supply joint device 3 and the liquid supply joint device 2 is the structure of the valve body 150. Specifically speaking, the difference between a valve body 150 and the aforementioned valve body 50 is that a valve-body-pressing pin 213 is set up from a generally central part of an end face 52 of the valve body 150.

As shown in FIGS. 10 and 11, the valve body 150 has the valve-body-pressing pin 213 which is set up from the generally central part of the end face 52. When an end face 410 of the liquid accepter housing 400 in which the liquid supply joint device 3 is placed is positioned opposite, and then connected to, the end face 110 of the liquid reservoir housing 100 in which the liquid supply joint device 2 is placed as shown in FIG. 11, the valve-body-pressing pin 213, instead of the valve-body-pressing pin 203, presses the valve body 50.

Specifically speaking, before the housing 100 in which the liquid supply joint device 2 is placed is connected to the housing 400 in which the liquid supply joint device 3 is placed as shown in FIG. 10, the valve body 50 of the liquid supply joint device 2 is closed by the force applied by the spring 80. Similarly, the valve body 150 of the liquid supply joint device 3 is closed by the force applied by the spring 80.

On the other hand, when the housing 100 in which the liquid supply joint device 2 is placed is connected to the housing 400 in which the liquid supply joint device 3 is placed as shown in FIG. 11, the valve-body-pressing pin 213 presses and moves the valve body 50 back toward the supply port 11 side of the liquid supply joint device 2 and, at the same time, the valve body 150 also moves back toward the supply port 11 side of the liquid supply joint device 3, thereby opening both the valve bodies 50 and 150. If the housing 100 is separated from the housing 400, the valve bodies 50 and 150 are closed again by the force applied by the springs 80. Accordingly, the liquid is made to flow from the liquid reservoir to the liquid accepter by making the housing 100 and the housing 400 be in contact with each other, and the liquid flow from the liquid reservoir to the liquid accepter is stopped by separating the housing 100 from the housing 400.

Incidentally, it is a matter of course that the liquid supply joint device 3 may be placed in the liquid reservoir housing 100 and that the liquid supply joint device 2 may be placed in the liquid accepter housing 400.

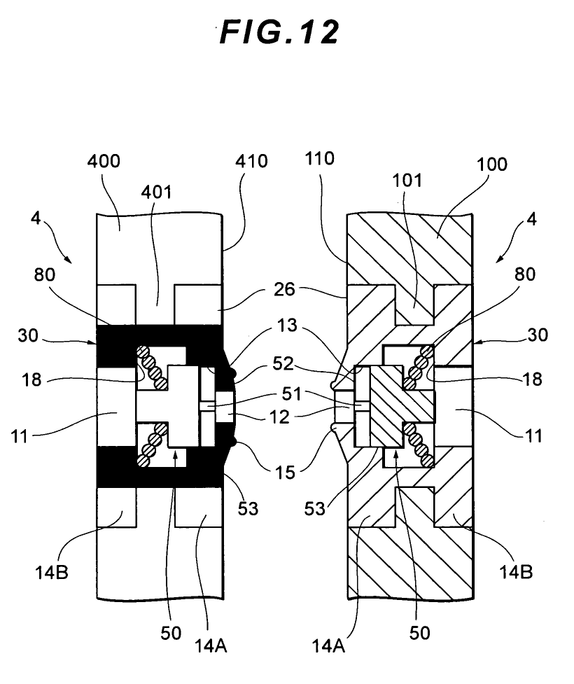

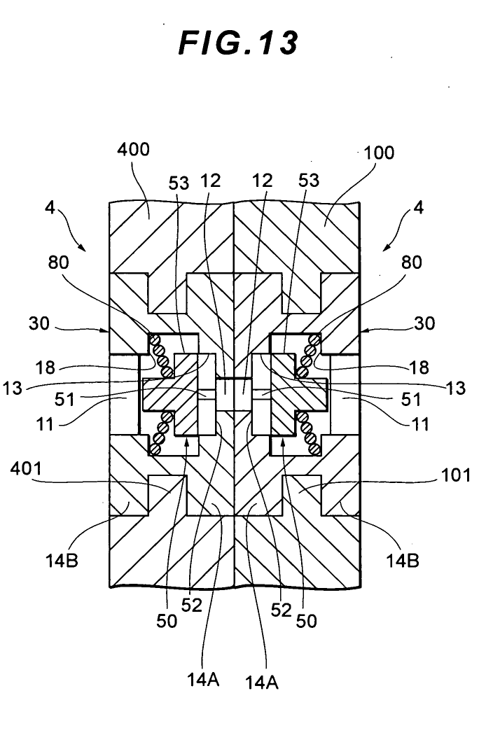

According to another embodiment, a liquid supply joint device 4 may be placed in the liquid reservoir housing 100 and the liquid accepter housing 400 as shown in FIGS. 12 and 13. The main difference between the liquid supply joint device 4 and the liquid supply joint device 2 is that a generally central part of the outside end face 26 of a housing 30 is raised outwards to form an inverted cup shape.

Before the housing 100 in which the liquid supply joint device 4 is placed is connected to the housing 400 in which the liquid supply joint device 4 is placed as shown in FIG. 12, their valve bodies 50 are closed by the force applied by the springs 80 respectively. On the other hand, when the housing 100 in which the liquid supply joint device 4 is placed is connected to the housing 400 in which the liquid supply joint device 4 is placed as shown in FIG. 13, the inverted-cup-shaped part that bulges outwards from the outside end face 26 of each housing 30 changes its shape and becomes flat and pushes the valve body 50 toward the supply port 11 side, thereby opening both the valve bodies 50. If the housing 100 is separated from the housing 400, the inverted-cup-shaped part, which bulges outwards from the outside end face 26 of each housing 30, elastically recovers its original shape, and each valve body 50 is closed by the force applied by the spring 80. Accordingly, the liquid is made to flow from the liquid reservoir to the liquid accepter by making the housing 100 and the housing 400 be in contact with each other, and the liquid flow from the liquid reservoir to the liquid accepter is stopped by separating the housing 100 from the housing 400.

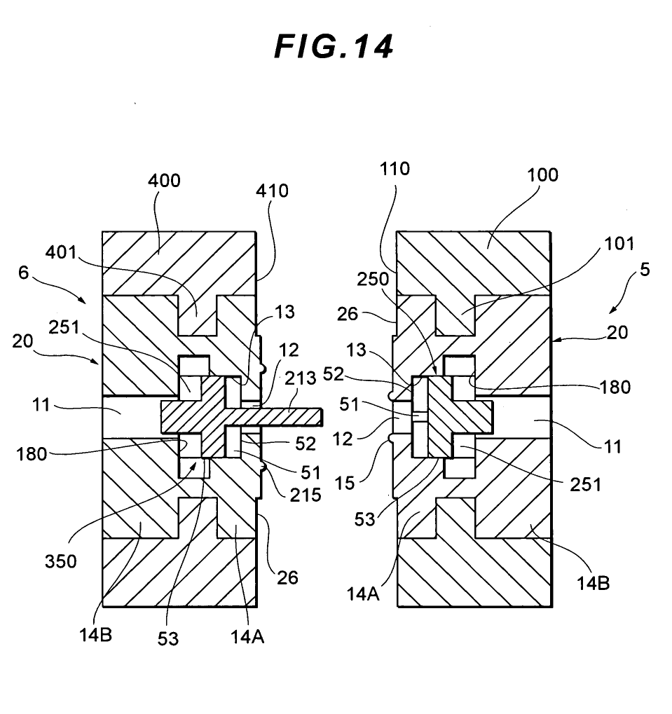

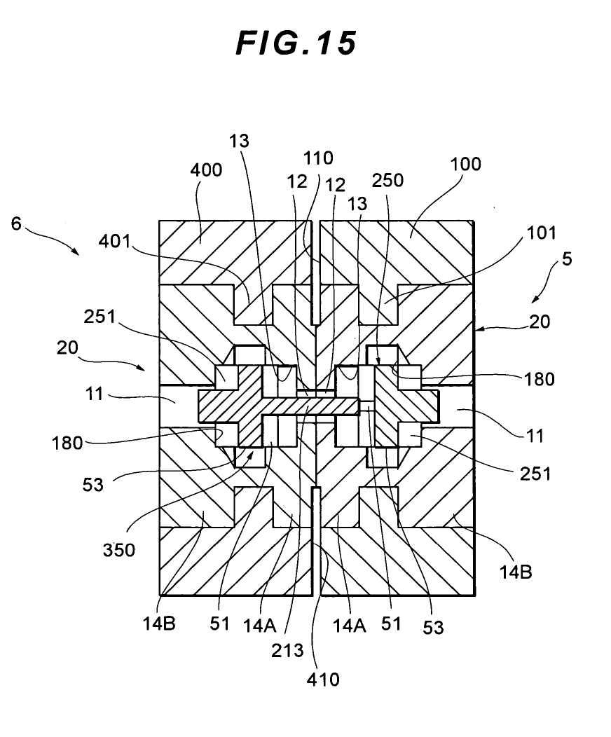

In the first and second embodiments, the spring 80 is provided as the force-applying member for applying force to the valve body 50 or the valve body 150. However, like in liquid supply joint devices 5 and 6 shown in FIGS. 14 and 15, a force-applying part 180 that is integrally formed with the inside wall of the housing 20 and applies force to each valve body 250 and 350 toward its closed position may be provided instead of the spring 80.

In this case, the valve body 250 of the liquid supply joint device 5 placed in the liquid reservoir housing 100 has grooves 251 in its end face in contact with the force-applying part 180, as shown in FIGS. 14 and 15. Because of these grooves 251, the contact area of the end face of the valve body 250 in contact with the force-applying part 180 is reduced, so that the pressure imposed on the force-applying part 180 increases. Incidentally, the structure of the valve body 250 is similar to that of the aforementioned valve body 50, except that the grooves 251 are formed in the valve body 250.

Similarly, the valve body 350 of the liquid supply joint device 6 placed in the liquid accepter housing 400 has grooves 251 in its end face in contact with the force-applying part 180 as shown in FIGS. 14 and 15. Because of these grooves 251, the contact area of the end face of the valve body 350 in contact with the force-applying part 180 is reduced, so that the pressure imposed on the force-applying part 180 increases. Incidentally, the structure of the valve body 350 is similar to that of the aforementioned valve body 150, except that the grooves 251 are formed in the valve body 350.

Before the housing 100 in which the liquid supply joint device 5 is placed is connected to the housing 400 in which the liquid supply joint device 6 is placed as shown in FIG. 14, the valve bodies 250 and 350 are closed respectively by the force-applying parts 180. On the other hand, when the housing 100 in which the liquid supply joint device 5 is placed is connected to the housing 400 in which the liquid supply joint device 6 is placed as shown in FIG. 15, the valve-body-pressing pin 213 presses the valve body 250 toward the supply port 11 side of the liquid supply joint device 5. As a result, the force-applying part 180 elastically changes its shape and the valve body 250 moves back toward the supply port 11 side of the liquid supply joint device 5. Similarly, the opposing action causes the valve body 350 to be pushed toward the supply port 11 side of the liquid supply joint device 6; the force-applying part 180 elastically changes its shape; and the valve body 350 moves back toward the supply port 11 side of the liquid supply joint device 6. As a result of this action, both the valve bodies 250 and 350 are opened.

When the housing 100 is separated from the housing 400, the force-applying parts 180 with elastic recovery power apply force to the valve bodies 250 and 350 respectively toward the discharge port 12 side, thereby closing the valve bodies 250 and 350 again. Accordingly, the liquid is made to flow from the liquid reservoir to the liquid accepter by making the housing 100 and the housing 400 in contact with each other, and the liquid flow from the liquid reservoir to the liquid accepter is stopped by separating the housing 100 from the housing 400.

Also in the structures according to other embodiments described above, the force-applying part 180 may be provided instead of the spring 80. It is a matter of course that the liquid supply joint device 5 may be placed in the liquid reservoir housing 400 and that the liquid supply joint device 6 may be placed in the liquid accepter housing 100.

What is claimed is:

1. A liquid supply joint device for connecting a liquid reservoir containing a liquid to a liquid accepter for receiving the liquid from the liquid reservoir, the liquid supply joint device comprising:
a housing that can be placed at at least one of the liquid reservoir and the liquid accepter and has a liquid supply port and a discharge port; and
a valve body that is placed and movable in the housing and opens or closes the supply port or the discharge port in accordance with movement of the valve body;
wherein either the housing or the valve body is composed of an elastic member, and
wherein the valve body has a sealing face that is generally parallel to the direction of its movement, and the valve body is closed when the sealing face is made to come into contact with the inside wall of the housing.

2. The liquid supply joint device according to claim 1, wherein the housing is composed of an elastic member.

3. The liquid supply joint device according to claim 1 or 2, wherein a force-applying member for applying force to the valve body to make it move is provided in the housing.

4. The liquid supply joint device according to claim 2, wherein a force-applying member for applying force to the valve body to make it move is formed integrally with the inside wall of the housing.

5. The liquid supply joint device according to claim 1, wherein channels for allowing the liquid to flow through are formed at an end portion of the valve body on the side to be closed; and when the valve body is opened, the liquid is made to flow through the channels.

6. The liquid supply joint device according to claim 1, wherein when the valve body moves, the sealing face slides along the inside wall of the housing.

7. The liquid supply joint device according to claim 6, wherein either at least the sealing face of the valve body or at least a sliding face of the housing along which the sealing face slides, or both are made of a sliding material.

8. Afuel cell system comprising:
a fuel cell;
a liquid reservoir containing liquid fuel;
a liquid accepter for receiving the liquid fuel from the liquid reservoir and supplying it to the fuel cell; and
the liquid supply joint device described in any one of claims 1 to 7.

9. The fuel cell system according to claim 8, wherein the liquid fuel contains methanol.
